(19) United States
(12) Patent Application Publication
(10) Pub. No.: US 2016/0167579 A1
(43) Pub. Date: Jun. 16, 2016

(54) APPARATUS AND METHOD FOR AVOIDING COLLISION

(71) Applicant: Hyundai Motor Company, Seoul (KR)

(72) Inventors: Dae Sung Hwang, Hwaseong (KR); Dong Gyu Noh, Dongducheon (KR); Cho Rong Ryu, Incheon (KR); Jong Rok Park, Seoul (KR); Hahk Rel Noh, Bucheon (KR); Su Lyun Sung, Anyang (KR)

(21) Appl. No.: 14/938,075

(22) Filed: Nov. 11, 2015

(30) Foreign Application Priority Data
Dec. 11, 2014 (KR) 10-2014-0178537

(51) Int. Cl. B60Q 9/00

(52) U.S. Cl. CPC B60Q 9/008

(57) ABSTRACT

The present disclosure relates to an apparatus and a method for avoiding a collision including: a communication module receiving location information from another vehicle; a sensor module obtaining a location of a user's vehicle; and a control module checking a central node of an intersection that exists in a road on which the user's vehicle and the other vehicle drive, determining whether a collision between the user's vehicle and the other vehicle at the intersection is possible, based on pre-stored map data and locations of the user's vehicle and the other vehicle, and outputting an alarm when it is determined that the collision is possible.

### CROSS-REFERENCE TO RELATED APPLICATION

This application claims the benefit of and priority to Korean Patent Application No. 10-2014-0178537, filed on Dec. 11, 2014 in the Korean Intellectual Property Office, the disclosure of which is incorporated herein in its entirety by reference.

### BACKGROUND OF THE DISCLOSURE

1. Technical Field

The present disclosure relates generally to an apparatus and a method for avoiding a collision, and more particularly, to a technology to prevent a collision with another vehicle at an intersection using vehicle-to-vehicle (V2V) communication.

2. Description of the Related Art

When passing through an intersection, a driver of a vehicle can avoid a collision with another vehicle when it is determined whether there is a vehicle that enters from the front, left, or right direction. However, it can be difficult for the driver to make such a determination while driving. Therefore, a collision avoidance apparatus to detect a vehicle that enters into an intersection based on a sensor or a radar to inform a driver has been developed.

When passing through the intersection, a conventional collision avoidance apparatus may detect a vehicle that enters from the left or right direction based on a sensor to warn the driver, and may activate the vehicle brakes in an emergency, thereby preventing a collision with other vehicle. Since the conventional collision avoidance apparatus detects the vehicle's surroundings using a laser sensor or an image sensor, there is a problem in that sensor errors may occur when weather conditions are bad, such that a collision with another vehicle cannot be prevented.

### SUMMARY OF THE DISCLOSURE

The present disclosure has been made in view of the above problems, and provides an apparatus and a method for avoiding a collision which can determine a location of other vehicle through a V2V communication, and predict a collision with other vehicle at an intersection based on map data, thereby preventing a collision with other vehicle at the intersection.

In accordance with embodiments of the present disclosure, an apparatus for avoiding a collision includes: a communication module receiving location information from another vehicle; a sensor module obtaining a location of a user's vehicle; and a control module checking a central node of an intersection that exists in a road on which the user's vehicle and the other vehicle drive, determining whether a collision between the user's vehicle and the other vehicle at the intersection is possible, based on pre-stored map data and locations of the user's vehicle and the other vehicle, and outputting an alarm when it is determined that the collision is possible.

Furthermore, in accordance with embodiments of the present disclosure, a method for avoiding a collision includes: determining a location of a user's vehicle; receiving location information from at least one other vehicle; determining a location of another vehicle based on the location information; checking a central node of an intersection that exists in a road on which the user's vehicle and the other vehicle drive based on pre-stored map data and locations of the user's vehicle and the other vehicle; determining whether a collision between the user's vehicle and the other vehicle at the intersection is possible, based on pre-stored map data and locations of the user's vehicle and the other vehicle; and outputting an alarm when it is determined that the collision is possible.

### BRIEF DESCRIPTION OF THE DRAWINGS

The objects, features and advantages of the present disclosure will be more apparent from the following detailed description in conjunction with the accompanying drawings, in which:

FIG. 1 is a diagram for describing an apparatus for avoiding a collision according to embodiments of the present disclosure;

FIG. 2 is a block diagram illustrating a main configuration of an apparatus for avoiding a collision according to embodiments of the present disclosure;

FIG. 3 is a diagram illustrating a node check for the intersection of a driving road in order to prevent a collision according to embodiments of the present disclosure;

FIG. 4 is a diagram illustrating a collision avoidance based on the driving direction of a user vehicle at the intersection according to embodiments of the present disclosure;

FIG. 5 is a diagram illustrating a collision avoidance at the intersection of a straight road according to embodiments of the present disclosure;

FIG. 6 is a diagram illustrating a collision avoidance at the intersection of a curved road according to embodiments of the present disclosure;

FIG. 7 is a flowchart illustrating a method for avoiding a collision according to embodiments of the present disclosure; and

FIG. 8 is a flowchart illustrating a node check for the intersection of a driving road in order to prevent a collision according to embodiments of the present disclosure.

### DETAILED DESCRIPTION OF EMBODIMENTS

Embodiments of the present disclosure are described with reference to the accompanying drawings in detail. The same reference numbers are used throughout the drawings to refer to the same or like parts. Detailed descriptions of well-known functions and structures incorporated herein may be omitted to avoid obscuring the subject matter of the present disclosure.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

Additionally, it is understood that one or more of the below methods, or aspects thereof, may be executed by at least one control module. The term “control module” may refer to a hardware device that includes a memory and a processor. The memory is configured to store program instructions, and the processor is specifically programmed to execute the program instructions to perform one or more processes which are described further below. Moreover, it is understood that the below methods may be executed by an apparatus comprising the control module in conjunction with one or more other components, as would be appreciated by a person of ordinary skill in the art.

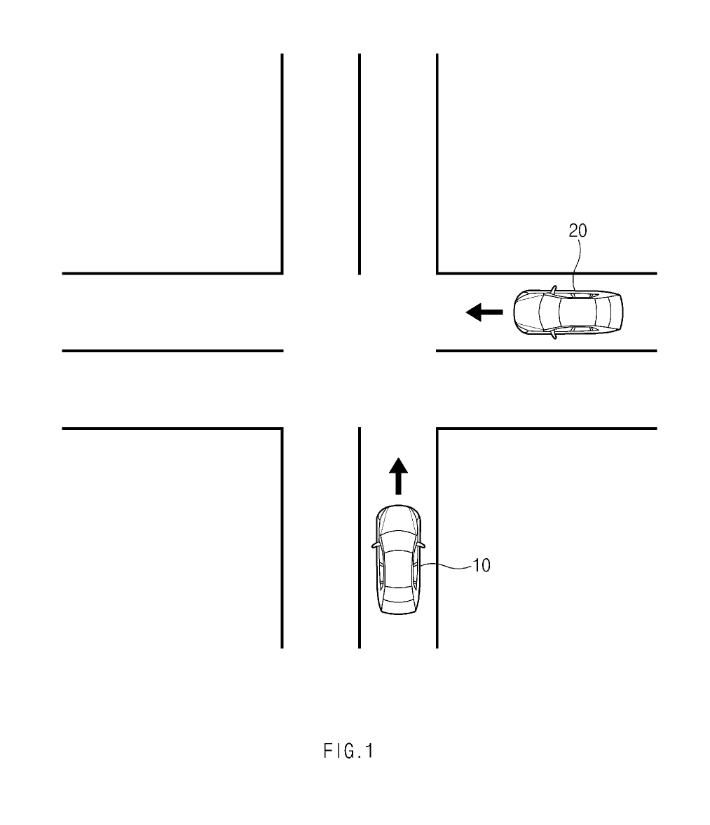

Referring now to the disclosed embodiments, FIG. 1 is a diagram for describing an apparatus for avoiding a collision according to embodiments of the present disclosure.

As shown in FIG. 1, the apparatus for avoiding a collision according to an embodiment of the present disclosure may be provided with a communication interface that supports a Vehicle to Vehicle (V2V) communication, and may communicate with other vehicle 20 which is located within a certain distance from a user's vehicle 10 (hereinafter referred to simply as “user vehicle) on a road and receive information on another vehicle 20. In addition, for convenience of explanation, it is illustrated that the V2V communication is accomplished. However, the embodiments are not limited thereto, but rather they are able to be changed and applied to a method that can accomplish a communication between the user vehicle 10 and the other vehicle 20 which are located within a certain distance.

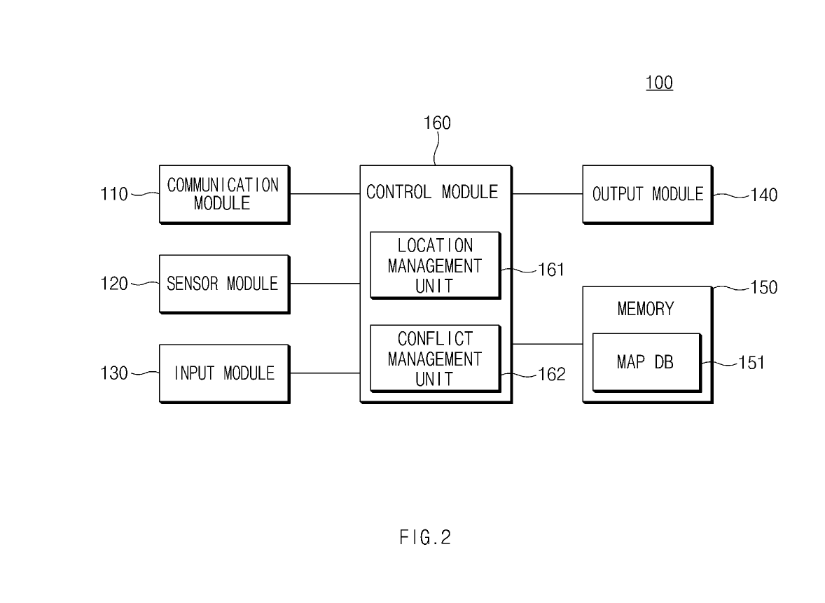

Like this, the apparatus for avoiding a collision mounted in the user vehicle 10 may receive location information of the other vehicle 20 from the other vehicle 20 using the V2V communication and may determine a location of the other vehicle 20. The apparatus for avoiding may determine whether there is a possibility of collision based on the location of the user vehicle 10 and other vehicle 20, and warn a driver beforehand when there is the possibility of the collision. A detailed description of a configuration of the apparatus for avoiding is illustrated with reference to FIG. 2.

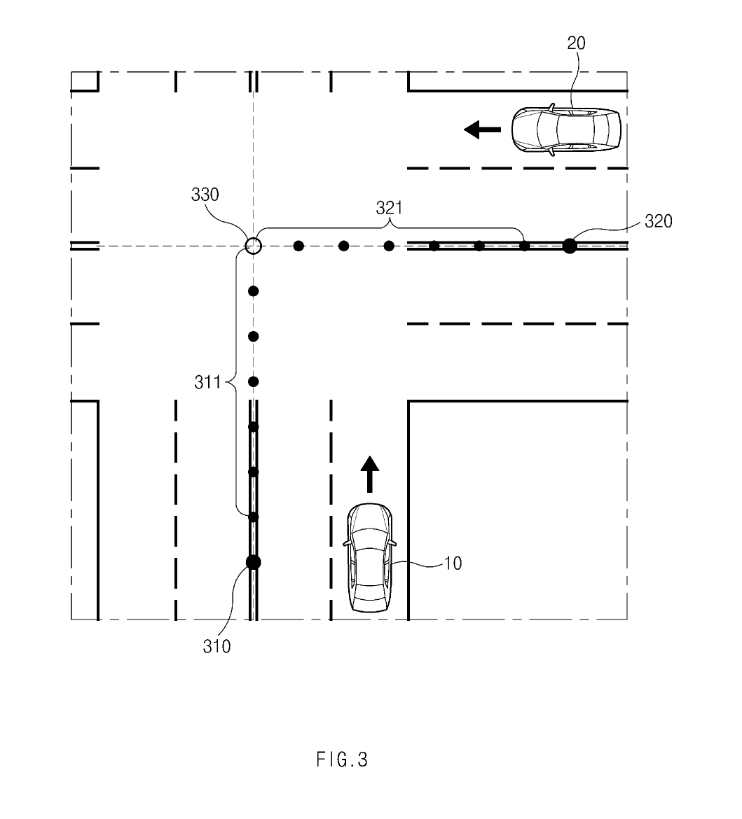

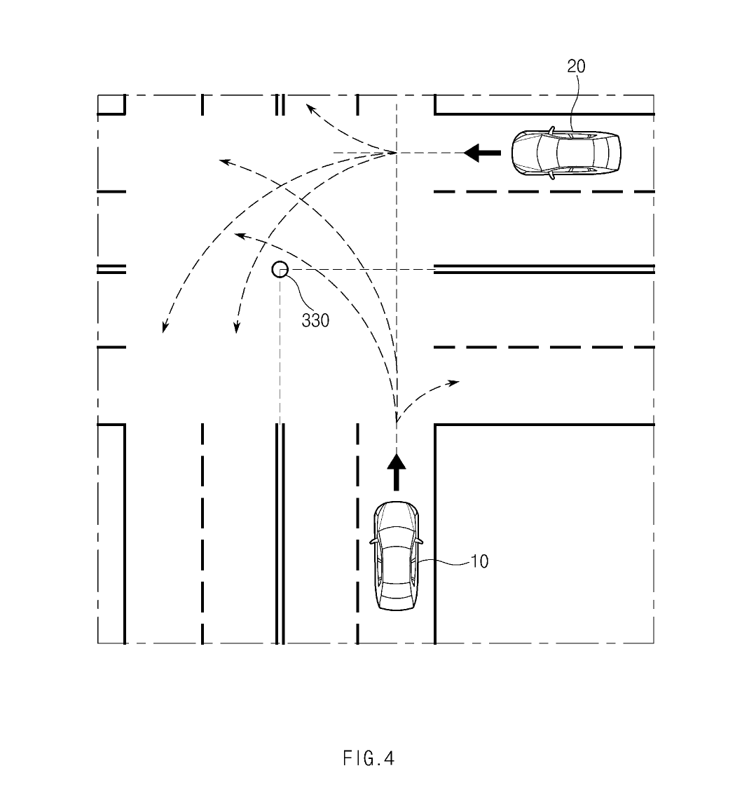

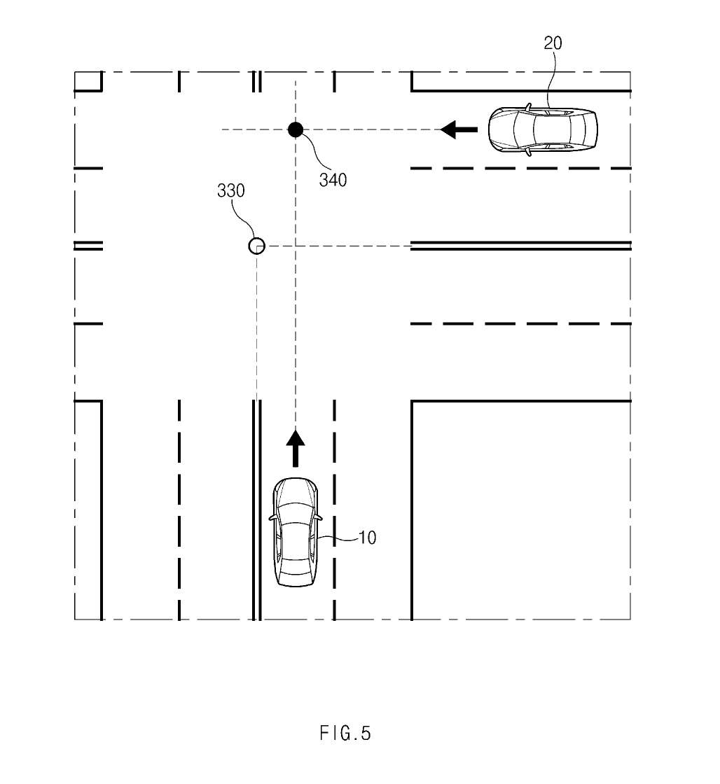

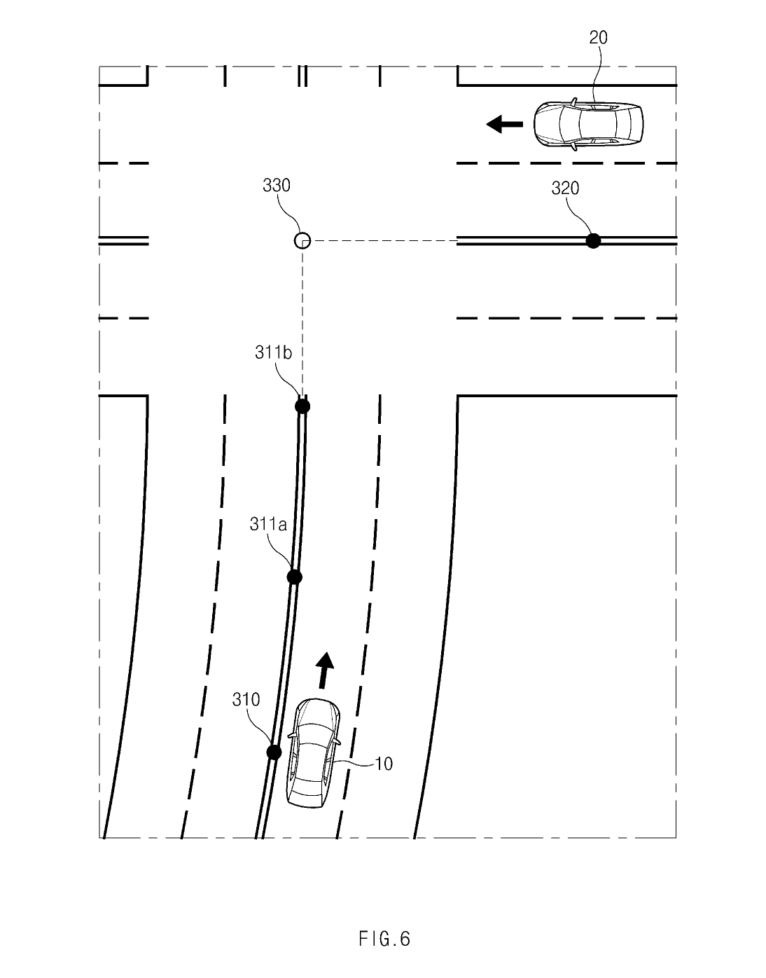

FIG. 2 is a block diagram illustrating a main configuration of an apparatus for avoiding a collision according to embodiments of the present disclosure. FIG. 3 is a diagram illustrating a node check for the intersection of a driving road in order to prevent a collision according to embodiments of the present disclosure. FIG. 4 is a diagram illustrating a collision avoidance based on the driving direction of a user vehicle at the intersection according to embodiments of the present disclosure. FIG. 5 is a diagram illustrating a collision avoidance at the intersection of a straight road according to embodiments of the present disclosure. FIG. 6 is a diagram illustrating a collision avoidance at the intersection of a curved road according to embodiments of the present disclosure.

As shown in FIG. 1 to FIG. 6, an apparatus 100 for avoiding a collision may include a communication module 110, a sensor module 120, an input module 130, an output module 140, a memory 150, and a control module 160.

The communication module 110 may perform a communication among the sensor module 120, the input module 130, the output module 140, the memory 150, and the control module 160, based on various methods such as Controller Area Network (CAN), CAN with Flexible Data rate (CAN-FD), FlexRay, Media Oriented Systems Transport (MOST), Time Triggered Ethernet (TT Ethernet), and the like. In addition, the communication module 110 may receive various information including location information and driving information of other vehicle 20 from other vehicle 20 through the V2V communication. For convenience of explanation, it is illustrated that the V2V communication is accomplished, but is the embodiments are able to be extended and applied to a Vehicle to everything (V2X) communication.

The sensor module 120 may include a Global Positioning System (GPS) and various sensors for sensing driving information in order to sense location information and driving information of the user vehicle 10. A sensor for sensing the driving information may include a speed sensor, an acceleration sensor, and the like. The sensor module 120 may provide sensing information of various sensors to the control module 160.

The input module 130 may generate a control signal according to an input from the outside. In particular, the input module 130 may generate a signal for setting a collision avoidance mode to prevent a collision with other vehicle 20 and provide the generated signal to the control module 160. To this end, the input module 130 may be formed of an input device such as a keypad, a touchpad, a touch screen, and the like, and the input module 130 may serve as an output module 140 simultaneously, when the input module 130 is formed of the touch screen.

The output module 140 may output an operation performed in the apparatus 100 for avoiding a collision. To this end, the output module 140 may include an output device (not shown) such as liquid crystal display (LCD), a touch screen, and the like, and may include a speaker (SPK) for outputting an alarm generated by the apparatus for avoiding a collision 100.

The memory 150 may store a program for operating the apparatus 100 for avoiding a collision. In particular, the memory 150 may store an algorithm for calculating the possibility of the collision between the user vehicle 10 and other vehicle 20. The memory 150 may include a MAP DB 151, and the MAP DB 151 may previously store map data used for determining the possibility of the collision between the user vehicle 10 and other vehicle 20.

The control module 160 may check a central node 330 of the intersection that exists in a road on which the user vehicle 10 and other vehicle 20 drive, based on the map data stored in the MAP DB 151 and the locations of the user vehicle 10 and other vehicle 20. The control module 160 may determine whether the collision between the user vehicle 10 and other vehicle 20 at the intersection is possible and output an alarm when there is a possibility of the collision. To this end, the control module 160 may include a location management unit 161, and a conflict management unit 162.

The location management unit 161 may manage the location of the user vehicle 10 and other vehicle 20. According to embodiments of the present disclosure, the location management unit 161 may analyze the sensing information supplied from the sensor module 120 and determine the location coordinate of the user vehicle 10. The location management unit 161 may analyze the location information received from other vehicle 20 through the communication module 110 and determine the location coordinate of other vehicle 20. The location management unit 161 may call the map data previously stored in the MAP DB 151 and may obtain respective matching coordinates 310 and 320 based on the location coordinate of the user vehicle 10 and the location coordinate of other vehicle 20.

Referring to FIG. 3, reference numeral 310 denotes the matching coordinate of the user vehicle 10, and reference numeral 320 denotes the matching coordinate of other vehicle 20. The location management unit 161 may extract at least one node 311 which is located within a threshold distance in a driving direction of the user vehicle 10 based on the matching coordinate 310 of the user vehicle 10. The location management unit 161 may extract at least one node 321 which is located within a threshold distance in a driving direction of other vehicle 20 based on the matching coordinate 310 of other vehicle 20. At this time, the matching coordinates 310 and 320 and at least one node 311 and 321 may be one of information indicating a lane in the map data.

If there is an overlap of node among at least one node 311 and 321, for example, if there is the same node, the location management unit 161 may set the same node to a central node 330 of the intersection. At this time, if the same node does not exist among at least one node 311 and 321, the location management unit 161 may determine that the intersection does not exist in the driving direction of the user vehicle 10 and other vehicle 20.

The conflict management unit 162 may determine the possibility of the collision between the user vehicle 10 and other vehicle 20 based on the central node 330 set by the location management unit 161. At this time, the conflict management unit 162 may predict the collision in consideration of a turn signal received from the user vehicle 10 and other vehicle 20 based on the central node 330, and may predict the collision depending on whether the intersection is formed in a straight road or a curved road based on the central node 330.

In embodiments of the present disclosure, when the turn signal is received from at least one of the user vehicle 10 and other vehicle 20, the conflict management unit 162 may predict the collision according to the turn signal. In this case, the turn signal may be a left turn signal or a right turn signal, and may be generated through a multi-function switch operation of the driver.

Hereinafter, the method of predicting a collision according to each turn signal is illustrated with reference to FIG. 4.

When a right turn signal is generated from the user vehicle 10, the collision management unit 162 may predict that the user vehicle 10 shall leave the intersection. In this case, the conflict management unit 162 may determine that no collision shall occur regardless of the location and the turn signal of other vehicle 20.

When a left turn signal is generated from the user vehicle 10 and a right turn signal is generated from the other vehicle 20, the user vehicle 10 may pass through the intersection, but the other vehicle 20 leaves the intersection. Hence, the conflict management unit 162 may determine that no collision shall occur.

When a left turn signal is generated from both the user vehicle 10 and the other vehicle 20, the conflict management unit 162 may determine the possibility of the collision in consideration of the same driving lane of the user vehicle 10 and other vehicle 20, the central node 330 of the intersection, the current location of the user vehicle 10 and the other vehicle 20, and driving information. The driving information may include, for example, a driving speed and an acceleration of each car. When the conflict management unit 162 determines that the user vehicle 10 and other vehicle 20 shall collide, the conflict management unit 162 may generate an alarm indicating the possibility of a collision with other vehicle 20 to output through the output module 140.

According to embodiments of the present disclosure, when the intersection located in the movement direction of the user vehicle 10 and other vehicle 20 exists in a straight road, the conflict management unit 162 may check a conflict condition of the user vehicle 10 and other vehicle 20. At this time, when an interpolation point does not exist between the matching coordinate 310 of the user vehicle 10 and the central node 330, the conflict management unit 162 may determine that the driving road of the user vehicle 10 is a straight road, whereas when the interpolation point exists, the conflict management unit 162 may determine that the driving road of the user vehicle 10 is a curved road. Here, the interpolation point is information that is included in the map data. When a starting point (e.g., the matching coordinate) and an end point (the central node) are known, the location coordinate may be detected as well as the existence of the interpolation point. The conflict management unit 162 may determine a relative mutual location based on the location coordinates of the user vehicle 10 and other vehicle 20 which are continuously managed by the location management unit 161.

As shown in FIG. 5, the conflict management unit 162 may extract an estimated collision location 340 by using the location coordinate and the driving direction of the user vehicle 10 and other vehicle 20. The conflict management unit 162 may check the driving information, for example, at least one of the driving speed and the acceleration of the user vehicle 10 and other vehicle 20, and calculate a time to reach the estimated collision location 340. The conflict management unit 162 may determine the possibility of the collision based on the calculated time. When there is the possibility of collision between the user vehicle 10 and other vehicle 20, the conflict management unit 162 may generate an alarm to inform a warning for the possibility of collision, and may output the alarm via the output module 140.

According to embodiments of the present disclosure, as shown in FIG. 6, when the intersection located in the movement direction of the user vehicle 10 and the other vehicle 20 exists in a curved road, the conflict management unit 162 may check a conflict condition of the user vehicle 10 and other vehicle 20. The conflict management unit 162 may check the estimated collision location by using the matching coordinate 310 according to the location coordinate of the user vehicle 10 which is continuously checked by the location management unit 161, the interpolation points 311a and 311b, and the central node 330.

The conflict management unit 162 may check the estimated collision location by using a value obtained by adding up a distance from the matching coordinate 310 to a first interpolation point 311a, a distance from the first interpolation point 311a to a second interpolation point 311b, and a distance from the second interpolation point 311b to the central node 330. The conflict management unit 162 may check the driving information, for example, at least one of the driving speed and the acceleration of the user vehicle 10 and other vehicle 20, and calculate a time to reach the estimated collision location. The conflict management unit 162 may determine the possibility of the collision based on the calculated time. When there is the possibility of collision between the user vehicle 10 and other vehicle 20, the conflict management unit 162 may generate an alarm to inform a warning for the possibility of collision, and may output the alarm via the output module 140.

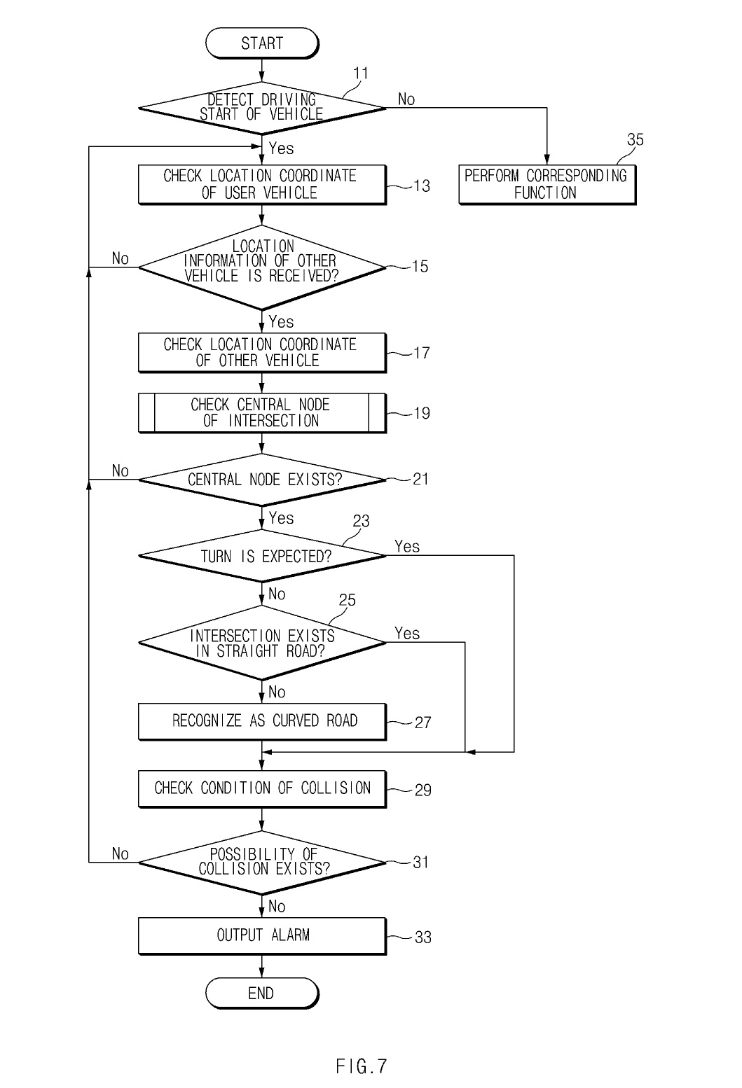

FIG. 7 is a flowchart illustrating a method for avoiding a collision according to embodiments of the present disclosure.

As shown in FIG. 2 to FIG. 7, at step 11, the control module 160 may check whether the driving of the vehicle is started. According to the check result of 11, when the driving start of the vehicle is detected, the control unit 160 proceeds to step 13. In addition, when the driving start of the vehicle is not detected, the control unit 160 proceeds to step 35. At step 35, the control module 160 may perform a corresponding function according to an input of a driver such as an in-vehicle temperature control, a window height control, and the like.

At step 13, the control module 160 may determine the location coordinate of the user vehicle by using the sensed information received from the GPS included in the sensor module 120. At step 15, the control module 160 may check whether the location information of other vehicle is received from other vehicle by using the V2V communication. When the location information of other vehicle is received from other vehicle at step 15, the control module 160 may proceed to step 17, whereas, when the location information of other vehicle is not received for a threshold time, the control module 160 may return to step 13 to check again the location coordinate according to the driving of the user vehicle.

At step 17, the control module 160 may determine the location coordinate of the other vehicle by analyzing the location information of other vehicle received from other vehicle. At step 19, the control module 160 may check the central node of the intersection using the location coordinate of user vehicle and the location coordinate of the other vehicle.

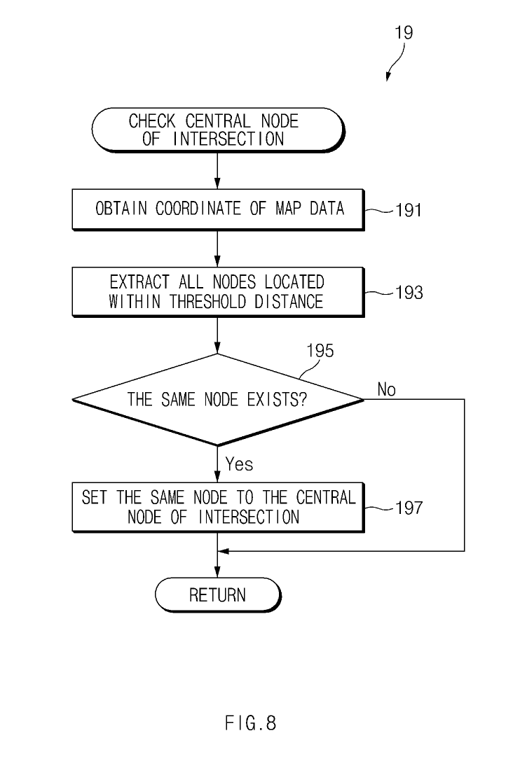

FIG. 8 is a flowchart illustrating a node check for the intersection of a driving road in order to prevent a collision according to embodiments of the present disclosure. Hereinafter, the step 19 is illustrated in detail with reference to FIG. 8. At step 191, the control module 160 may call the map data stored in the MAP DB 151 of the memory 150. The control module 160 may obtain respective matching coordinates which are matched to the map data by using the location coordinate of user vehicle and the location coordinate of other vehicle. This may be indicated as shown in FIG. 3. The reference numeral 310 of FIG. 3 may indicate the matching coordinate which is obtained by matching the location coordinate of the user vehicle 10 to the map data, and the reference numeral 320 may indicate the matching coordinate which is obtained by matching the location coordinate of other vehicle 20 to the map data.

At step 193, the control module 160 may extract at least one node 311 based on the matching coordinate 310 of the user vehicle 10. In this case, at least one node 311 may be a node which is located within a threshold distance in the driving direction of the user vehicle 10. The control module 160 may extract at least one node 321 based on the matching coordinate 320 of other vehicle 20. In this case, at least one node 321 may be a node which is located within a threshold distance in the driving direction of other vehicle 20.

At step 195, the control module 160 may determine whether the same node exists in at least one node 311 for the user vehicle 10 and at least one node 312 for other vehicle 20. According to the determination result at step 195, when the same node exists in at least one node 311 for the user vehicle 10 and at least one node 312 for other vehicle 20, the control module 160 proceeds to step 197. At step 197, the control module 160 may set the same node to the central node 330 of the intersection, and proceeds to step 21. When the same node does not exist, the control module 160 proceeds to step 21.

At step 21, according to the check result at step 19, when the central node 330 of the intersection exists, the control module 160 proceeds to step 23, whereas, when the central node 330 of the intersection does not exist, the control module 160 may determine that the intersection does not exist in the driving direction of the user vehicle and other vehicle and return to step 13.

At step 23, when the turn of the user vehicle or other vehicle is expected, that is, when a turn signal is generated, the control module 160 may perform step 29, and, when the turn signal is not generated, the control module 160 may perform step 25.

At step 29, the control unit 160 may check the condition of the collision between the user vehicle and other vehicle. According to embodiments of the present disclosure, when a right turn signal is generated from the user vehicle 10 entering the intersection, the control module 160 may determine that the user vehicle 10 will leave the intersection, and proceeds to step 31. At step 31, the control module 160 may determine that a conflict shall not occur regardless of the location of other vehicle 20 and the turn signal because it is determined that the user vehicle 10 will leave the intersection. The control module 160 may return to step 13.

According to embodiments of the present disclosure, when a left turn signal is generated from the user vehicle 10 which will enter the intersection and a right turn signal is generated from other vehicle 20, the control module 160 proceeds to step 31. At step 31, the control module 160 may determine that a conflict shall not occur because other vehicle 20 will leave the intersection even though the user vehicle 10 passes through the intersection. The control module 160 may return to step 13.

According to embodiments of the present disclosure, when a left turn signal is generated from the user vehicle 10 entering the intersection and a left turn signal is generated from other vehicle 20, the control module 160 proceeds to step 31. At step 31, the control module 160 may determine the possibility of the collision 20 in consideration of the same of the lanes on which the user vehicle 10 and other vehicle 20 drive respectively, the current location of the user vehicle 10 and other vehicle 20, and the driving information of the user vehicle 10 and other vehicle 20. At this time, the driving information may be at least one of the driving speed of each vehicle or the acceleration. According to the check result of step 31, when there is no possibility of collision between the user vehicle 10 and other vehicle 20, the control module 160 returns to step 13. According to the check result of step 31, when there is a possibility of collision between the user vehicle 10 and other vehicle 20, the control module 160 proceeds to step 33. At step 33, the control module 160 may output an alarm notifying that there is a possibility of the collision with other vehicle 20 through the output module 140.

At step 25, the control module 160 may check whether the intersection existing in the moving direction of the user vehicle and other vehicle exists in a straight road, when a left turn signal and a right turn signal are not generated from the user vehicle or other vehicle at step 23. This may be checked by the map data.

According to the check result of step 25, when the intersection exists on the straight road, the control module 160 may perform step 29. At step 29, the control unit 160 may check the condition of the collision between the user vehicle and other vehicle. At step 29, the control module 160 may check the relative location of each other based on the location coordinates of the user vehicle and other vehicle, and the control module 160 may extract the estimated collision location 340 of the user vehicle 10 and other vehicle 20 as shown in FIG. 5. The control module 160 may check the driving information, for example, at least one of the driving speed or the acceleration of the user vehicle 10 and other vehicle 20, and may calculate a time to reach the estimated collision location 340. At step 31, the control module 160 may check whether there is a possibility of the collision by determining the risk of the collision based on the calculated time. According to the check result of step 31, when there is the possibility of collision, the control module 160 may proceed to step 33 and output an alarm to inform a warning for the possibility of collision, and may return to step 13 when there is no possibility of collision.

According to the check result of step 25, when the intersection does not exist on the straight road, the control module 160 may perform step 27. At step 27, the control module 160 may recognize that the intersection exists on a curved road as shown in FIG. 6, and may perform step 29. At step 29, the control module 160 may check the condition of the collision between the user vehicle and other vehicle. At step 29, the control module 160 may check the estimated collision location by using the matching coordinate 310 of the user vehicle 10, the interpolation points 311a and 311b, and the central node 330. The control module 160 may check the driving information, for example, at least one of the driving speed or the acceleration of the user vehicle 10 and other vehicle 20, and may calculate a time to reach the estimated collision location. At step 31, the control module 160 may check whether there is a possibility of the collision by determining the risk of the collision based on the calculated time. According to the check result of step 31, when there is the possibility of collision, the control module 160 may output an alarm to inform a warning for the possibility of collision, and may return to step 13 when there is no possibility of collision.

The present disclosure may determine a location of other vehicle through the V2V communication, and predict a collision with other vehicle at the intersection based on the map data, thereby preventing a collision with other vehicle at the intersection.

Although embodiments of the present disclosure have been described in detail hereinabove, it should be clearly understood that many variations and modifications of the basic inventive concepts herein taught which may appear to those skilled in the present art will still fall within the spirit and scope of the present disclosure, as defined in the appended claims.

What is claimed is:

1. An apparatus for avoiding a collision, the apparatus comprising:
a communication module receiving location information from another vehicle;
a sensor module obtaining a location of a user's vehicle; and
a control module checking a central node of an intersection that exists in a road on which the user's vehicle and the other vehicle drive, determining whether a collision between the user's vehicle and the other vehicle at the intersection is possible, based on pre-stored map data and locations of the user's vehicle and the other vehicle, and outputting an alarm when it is determined that the collision is possible.

2. The apparatus of claim 1, wherein the control module obtains respective coordinates matched to the location of the user's vehicle and the location of the other vehicle from the map data.

3. The apparatus of claim 2, wherein the control module extracts at least one node located within a threshold distance from a corresponding matching coordinate based on the user's vehicle and extracts at least one node located within a threshold distance from a corresponding matching coordinate based on a driving direction of the other vehicle.

4. The apparatus of claim 3, wherein the control module extracts the same node as a central node of the intersection when there is the same node among the at least one extracted node.

5. The apparatus of claim 2, wherein the control module determines whether the collision is possible by checking driving information of the user's vehicle and the other vehicle when the intersection exists in a straight road.

6. The apparatus of claim 2, wherein the control module determines whether the collision is possible using the respective coordinates, an interpolation point, the central node, and driving information of the user's vehicle and the other vehicle when the intersection exists in a curved road.

7. The apparatus of claim 2, wherein the control module determines whether the collision is possible based on a turn signal generated from at least one of the user's vehicle and the other vehicle, a driving lane on which the respective vehicles drive, the central node, a current location of the user's vehicle and the other vehicle, and driving information of the user's vehicle and the other vehicle.

8. A method for avoiding a collision, the method comprising:
determining a location of a user's vehicle;
receiving location information from at least one other vehicle;
determining a location of another vehicle based on the location information;
checking a central node of an intersection that exists in a road on which the user's vehicle and the other vehicle drive based on pre-stored map data and locations of the user's vehicle and the other vehicle;
determining whether a collision between the user's vehicle and the other vehicle at the intersection is possible, based on pre-stored map data and locations of the user's vehicle and the other vehicle; and
outputting an alarm when it is determined that the collision is possible.

9. The method of claim 8, further comprising:
obtaining respective coordinates matched to the location of user's vehicle and the location of the other vehicle from the map data.

10. The method of claim 9, further comprising:
extracting at least one node located within a threshold distance from a corresponding matching coordinate based on a driving direction of the user's vehicle; and
extracting at least one node located within a threshold distance from a corresponding matching coordinate based on a driving direction of the other vehicle.

11. The method of claim 10, further comprising:
determining whether there is the same node among the at least one node;
extracting the same node as the central node, when there is the same node; and
determining that the intersection does not exist in the road on which the user's vehicle and the other vehicle drive when the same node does not exist.

12. The method of claim 9, further comprising:
determining whether the collision is possible by checking driving information of the user's vehicle and the other vehicle when the intersection exists in a straight road.

13. The method of claim 9, further comprising:
determining whether the collision is possible using the respective coordinates, an interpolation point, the central node, and driving information of the user's vehicle and the other vehicle when the intersection exists in a curved road.

14. The method of claim 9, further comprising:
determining whether the collision is possible based on a turn signal generated from at least one of the user's vehicle and the other vehicle, a driving lane on which the respective vehicles drive, the central node, a current location of the user's vehicle and the other vehicle, and driving information of the user's vehicle and the other vehicle.
